(19) United States
(12) Patent Application Publication
(10) Pub. No.: US 2020/0387689 A1
(43) Pub. Date: Dec. 10, 2020

(54) TERMINAL AND METHOD OF MANUFACTURING THE SAME

(71) Applicant: VIVO MOBILE COMMUNICATION CO.,LTD., Chang'an Dongguan (CN)

(72) Inventor: Jianfeng WANG, Chang'an Dongguan (CN)

(73) Assignee: VIVO MOBILE COMMUNICATION CO.,LTD., Chang'an Dongguan (CN)

(21) Appl. No.: 16/988,473

(22) Filed: Aug. 7, 2020

Related U.S. Application Data
(63) Continuation of application No. PCT/CN2019/073852, filed on Jan. 30, 2019.

(30) Foreign Application Priority Data
Feb. 9, 2018 (CN) 201810135386.5

(51) Int. Cl. G06K 9/00; H04M 1/02

(52) U.S. Cl. CPC G06K 9/00053; H04M 2250/12; H04M 1/0266

(57) ABSTRACT

The present disclosure provides a terminal and a method of manufacturing the terminal. The terminal includes a display module and a fingerprint identification assembly. The fingerprint identification assembly includes: a fingerprint collection layer, attached to the display module and configured to collect fingerprint information; a fingerprint identification module, configured to identify the fingerprint information; and a flexible circuit board. The flexible circuit board is led out from a side edge of the fingerprint collection layer, and is connected to the fingerprint identification module.

### CROSS-REFERENCE TO RELATED APPLICATION

The present application is a continuation application of PCT International Application No. PCT/CN2019/073852 filed on Jan. 30, 2019, which claims a priority of the Chinese patent application No. 201810135386.5 filed on Feb. 9, 2018, which are incorporated herein by reference in their entireties.

### TECHNICAL FIELD

The present disclosure relates to the technical field of a terminal, in particular to a terminal and a method of manufacturing the terminal.

### BACKGROUND

FIG. 1 is a schematic diagram showing an assembly structure of a fingerprint module on a mobile phone. As shown in FIG. 1, the fingerprint module on the mobile phone may be separately designed, and can include a fingerprint chip package 10, a protective film 20, a metal ring 30, a flexible printed circuit (FPC) 40, a component 50 and a connector 60. As shown in FIG. 2, the fingerprint chip package 10 may include a substrate 11, a fingerprint chip die 12 provided on the substrate 11, a Die Attach Film (DAF) 13 arranged between and connected to the substrate 11 and the fingerprint chip die 12, and an encapsulation layer 14, which can comprise a sensor pattern for collecting fingerprint information of a finger and generating a corresponding sensing signal, and is arranged on the fingerprint chip die 12.

The fingerprint module may be designed separately under a Liquid Crystal Display Module (LCM). The size limitation of the fingerprint chip package 10 requires a dedicated space to be reserved for the fingerprint module. The fingerprint module is generally arranged on the bottom of the front of the mobile phone, the side of the mobile phone, or the back of the mobile phone. When the fingerprint module is placed on the bottom of the front of the mobile phone, it is difficult to achieve a sufficiently large screen-to-body ratio. When the fingerprint module is placed on the side of the mobile phone, the fingerprint identification rate may be low enough due to the size of the fingerprint identification sensor to adversely impact the user experience. When the fingerprint module is placed on the back of the mobile phone, the industry design may be adversely affected.

It can be seen that the design of a fingerprint module arranged under a liquid crystal display may be limited by the thickness of the fingerprint module when the fingerprint module is attached under an LCM, which can impact the structure of the mobile phone and/or the battery size.

### BRIEF DESCRIPTION OF THE DRAWINGS

FIG. 1 is a schematic structural diagram of a fingerprint module;

FIG. 2 is a schematic structural diagram of a fingerprint chip package;

FIG. 3 is a schematic perspective view of a terminal;

FIG. 4 is a schematic cross-sectional view of a terminal;

FIG. 5 is a schematic perspective structural view of a terminal;

FIG. 6 is a schematic cross-sectional view of a terminal; and

FIG. 7 is a schematic diagram of signal lines in a fingerprint collection layer of a terminal.

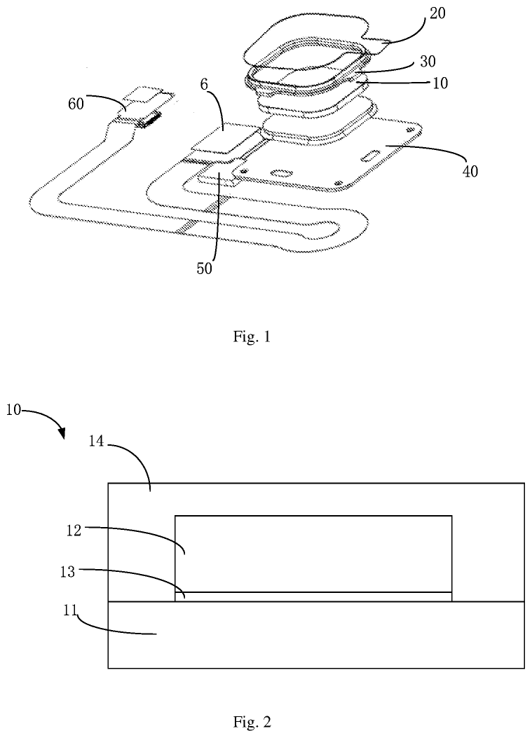

### DETAILED DESCRIPTION

In order to make the objects, the technical solutions and the advantages of the present disclosure more apparent, the present disclosure will be described hereinafter in a clear and complete manner in conjunction with the drawings and embodiments.

The present disclosure describes a terminal and a method of manufacturing the terminal, which can solve the problem that the placement of the fingerprint module is limited due to the limited size of the fingerprint module.

As used herein, a terminal means a mobile phone or any other portable device that incorporates a touch sensor module. The device may be capable of supporting any or all of cellular, WiFi, Bluetooth, RFID, NFC, ultra wideband, Ethernet, and other communication protocols. The touch sensor module may be a capacitive (PCT), optical, ultrasonic, or any other type of touch sensor module, as would be understood by those of skill in the art.

In a first aspect, an embodiment of the present disclosure provides a terminal, which includes a display module and a fingerprint identification assembly. The fingerprint identification assembly includes: a fingerprint collection layer, attached to the display module and configured to collect fingerprint information; a fingerprint identification module, configured to identify the collected fingerprint information; and a flexible circuit board, wherein the flexible circuit board is led out from a side edge of the fingerprint collection layer, and is connected to the fingerprint identification module.

In a second aspect, an embodiment of the present disclosure provides a method of manufacturing a terminal. The method includes: forming a fingerprint collection layer on a display module, binding the fingerprint collection layer to a flexible circuit board, and binding the flexible circuit board to a fingerprint identification module.

In a terminal provided by an embodiment of the present disclosure, a fingerprint collection layer is provided on a display module, that is, a fingerprint collection layer (sensor pattern) on a fingerprint chip die of a fingerprint identification assembly is separately integrated into the display module, and the fingerprint collection structure is led out from a flexible circuit board to connect to a fingerprint identification module. In this way, since the fingerprint collection layer does not need to be packaged, it may be directly attached to the display module, and thinning of the fingerprint identification assembly can be enhanced. The area of the fingerprint collection layer is not limited; it can be integrated at any position on the display module, or the entire display module can comprise a fingerprint identification area (i.e., the fingerprint collection layer can cover the entire display area of the display module). In addition, the fingerprint collection layer can be led out from the flexible circuit board and connected to a sensor processing module, mitigating impact to the mobile phone structure and/or the battery size. In addition, since the fingerprint identification layer can be attached to the display module, it can not only be placed under the display screen, but could also be placed above the display screen.

When the fingerprint module is designed separately, the placement options for the fingerprint identification module are limited based on the size of the fingerprint module. Embodiments of the present disclosure provide a terminal and a method of manufacturing the terminal that provide more freedom for the choice of the placement of the fingerprint identification module.

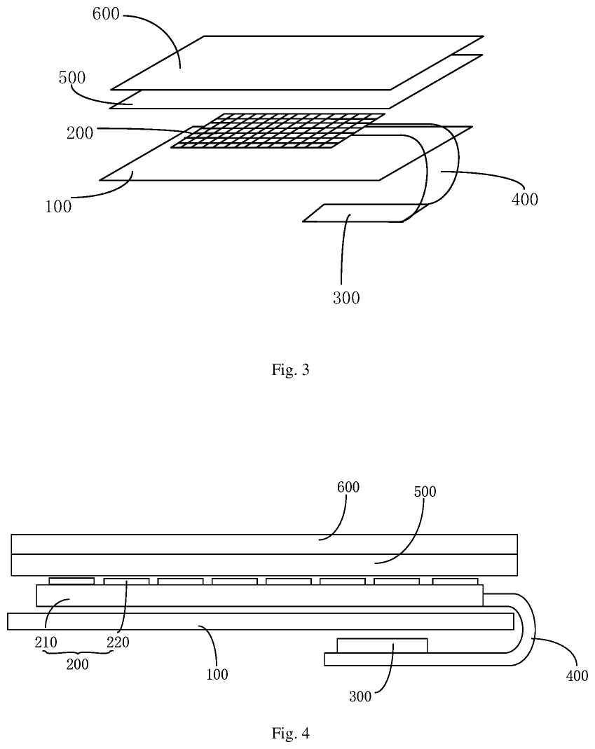

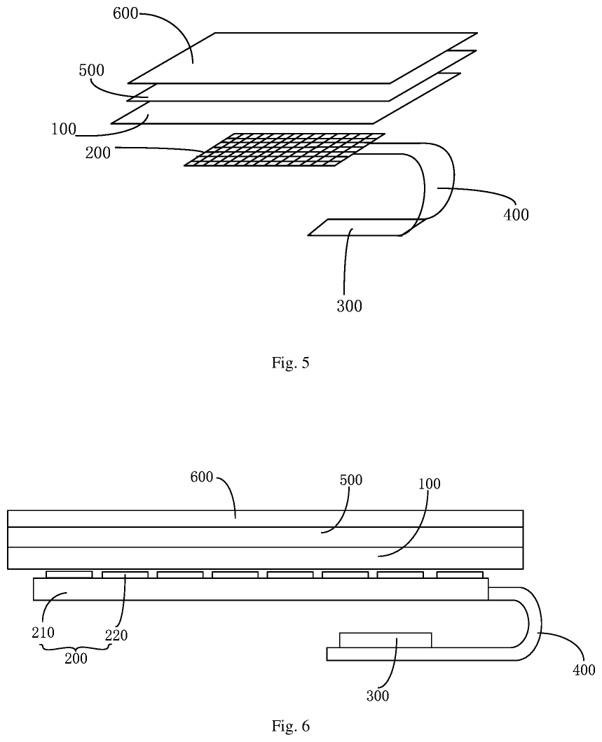

FIGS. 3 to 6 are schematic structural diagrams of a terminal provided in embodiments of the present disclosure, in which only components such as a display screen and a fingerprint identification assembly are illustrated, and other components known to those of skill such as, e.g., a backlight module, a keypad, an antenna, a housing, and others, are not illustrated.

As shown in FIGS. 3 to 6, a terminal provided by embodiments of the present disclosure includes a display module and a fingerprint identification assembly. The fingerprint identification assembly includes: a fingerprint collection layer 200, attached to the display module and used to collect fingerprint information; a fingerprint identification module 300, used to identify the collected fingerprint information; and a flexible circuit board 400, led out from a side edge of the fingerprint collection layer 200 and connected to the fingerprint identification module 300.

In a terminal provided by embodiments of the present disclosure, the fingerprint collection layer 200 may be provided on the display screen 100, and the fingerprint collection layer 200 may be a fingerprint collection structure (sensor pattern) on a fingerprint chip die of the fingerprint identification assembly. The fingerprint collection structure on the fingerprint chip die of the fingerprint identification assembly may be separately integrated into the display module, and the fingerprint collection structure may be led out from the flexible circuit board 400 and connected to the fingerprint identification module 300. In this way, since the fingerprint collection layer 200 does not need to be packaged, it can be directly attached to the display module, and the thickness of the fingerprint identification assembly can be minimized; and the placement area of the fingerprint collection layer 200 is not limited: it can be integrated at any position on the display module, or the entire display module can comprise a fingerprint identification area (i.e., the fingerprint collection layer 200 can cover the entire display area of the display module). In addition, the fingerprint collection layer 200 may be led out from the flexible circuit board 400 and is connected to a sensor processing module without impacting the structure of the terminal or the size of the battery in the terminal. In addition, since the fingerprint identification assembly is attached to the display screen 100, it can not only be placed under the display screen 100, but could also be placed above the display screen 100.

It should be noted that in the above description, the term “display module” refers to a screen portion of a terminal including a display screen 100. The display module may include at least a display screen 100, a touch screen 500, and a protective cover plate 600, and the fingerprint collection 200 layer may be attached to one side surface of any one of the display screen 100, the touch screen 500, and the protective cover plate 600.

In a terminal provided by the embodiments of the present disclosure, as shown in FIGS. 3 to 7, the fingerprint collection layer 200 includes: a substrate layer 210; a detection element (not shown in the figure) provided on the substrate layer 210; and a signal line 220 disposed on the substrate layer 210. The signal line 220 includes a reception signal line (Rx) 221 and a transmission signal line (Tx) 222 that are arranged perpendicularly with respect to each other.

In the above description, the detection element and the signal line 220 in the structure of the fingerprint collection layer 200 may comprise a fingerprint identification sensor pattern on a fingerprint identification chip die of a fingerprint chip package in the fingerprint identification module 300. The substrate layer 210 may be used to provide a film layer for the detection element and the signal line 220 to form the detection element and the signal line 220 on the substrate layer 210.

The fingerprint identification assembly may be any of various fingerprint identification assemblies know to those of skill such as, for example, an optical fingerprint identification assembly, a semiconductor fingerprint identification assembly, an ultrasonic fingerprint identification assembly, etc. The semiconductor fingerprint identification assembly would include a capacitive fingerprint identification assembly or an inductive fingerprint identification assembly. It would be understood by those of skill that the fingerprint identification assembly is not limited to the above types of fingerprint identification assembly.

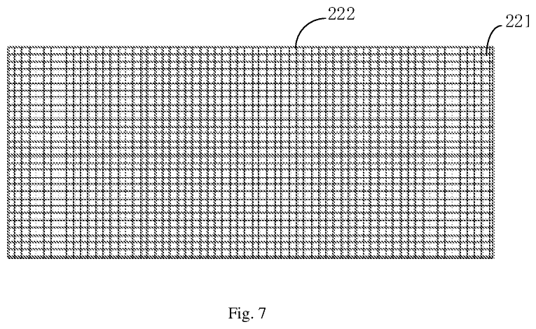

Taking an optical fingerprint identification assembly as an example, the detection element in the fingerprint collection layer 200 may include a photoelectric sensitive element, as shown in FIG. 7, the signal line 220 may include a reception signal line (Rx) 221 and a transmission signal line (Tx) 222 that are arranged perpendicularly with respect to each other. The structure and working principle of the optical fingerprint identification assembly are well known to those skilled in the art, and the terminal provided in the embodiments of the present disclosure may integrate the fingerprint collection structure (sensor pattern) on the fingerprint identification chip die of the fingerprint chip package in the optical fingerprint identification assembly on one side surface of the display screen 100. Description of the specific structures of the detection element and the signal line 220 of the optical fingerprint collection layer 200 is not repeated herein for purposes of brevity, as would be understood by those of skill. Similarly, when the fingerprint identification assembly is a semiconductor fingerprint identification assembly or an ultrasonic fingerprint identification assembly, description of the specific structures of the detection element and the signal line 220 in the fingerprint collection layer 200 is not repeated herein.

In an embodiment of the present disclosure, the substrate layer 210 serves as a film layer of the detection element and the signal line 220. The substrate layer 210 may be made of optically transparent materials such as silicon, glass, acrylic, or optical film.

In addition, in the embodiment of the present disclosure, the display module includes a driver integrated circuit (IC), and the fingerprint identification module 300 is integrated with the driver IC.

In an embodiment, a driver IC of the display screen 100 may be integrated with the fingerprint identification module 300. The fingerprint identification module 300 and the driver IC of the display screen 100 can be disposed on one side of the display screen 100 away from its display surface, and the flexible circuit board 400 of the fingerprint identification assembly is led out from one side of the fingerprint collection layer 200 and bent toward a side of the fingerprint collection layer 200 away from the display surface of the display screen 100, and connected to the fingerprint identification module 300. Another flexible circuit board 400 can be connected to one edge of the display screen 100, the flexible circuit board 400 on the display screen 100 being bent toward a side of the fingerprint collection layer 200 away from the display surface of the display screen 100, and connected to a driver IC. In this way, the occupied space can be further reduced, and the entire terminal layout can be utilized. It can be understood that, in practical applications, the fingerprint identification module 300 may also be disposed separately.

In an aspect, as a terminal provided by the present disclosure integrates the fingerprint collection layer 200 on the display module, the fingerprint collection layer 200 may be disposed either above or under the display screen 100, and the display screen 100 may include a display surface and a back surface opposite to the display surface, the touch screen 500 may be disposed on a side of the display surface of the display screen 100, and the protective cover plate 600 may be disposed on a side of the touch screen 500 away from the display screen 100. In one embodiment, as shown in FIGS. 3 to 6, the fingerprint collection layer 200 is attached to the back surface of the display screen 100. In another embodiment, the fingerprint collection layer 200 is attached between the display screen 100 and the touch screen 500. In addition, the fingerprint collection layer 200 may be attached between the touch screen 500 and the protective cover plate 600.

Compared with a fingerprint identification module that can only be arranged under the display screen 100 due to its size, the terminal provided in the embodiments of the present disclosure, enables placement of the fingerprint collection layer 200 without limitation.

An embodiment of the present disclosure provides a method of manufacturing a terminal, which is used to manufacture the terminal provided by the embodiments of the present disclosure. The method includes the following steps.

Step S1: Forming a fingerprint collection layer 200 on a display module.

Step S2: Binding the fingerprint collection layer 200 and a flexible circuit board 400.

Step S3: Binding the flexible circuit board 400 and a fingerprint identification module 300.

In accordance with the method provided in the embodiments of the present disclosure, the fingerprint collection layer 200 is directly formed on the display module. The fingerprint collection layer 200 may comprise a fingerprint collection structure (sensor pattern) on a fingerprint chip die of the fingerprint identification assembly. The fingerprint collection structure on the fingerprint chip die of the fingerprint identification assembly may be separately integrated into one side surface of the display screen 100, and the fingerprint collection structure may be led out from the flexible circuit board 400 and connected to the fingerprint identification module 300. In this way, since the fingerprint collection layer 200 does not need to be packaged, it can be directly attached to the display module, and the thickness of the fingerprint identification assembly can be minimized; and the placement area of the fingerprint collection layer 200 is not limited: it can be integrated at any position on the display module, or the entire display module can comprise a fingerprint identification area (i.e., the fingerprint collection layer 200 can cover the entire display area of the display module). In addition, the fingerprint collection layer 200 may be led out from the flexible circuit board 400 and is connected to a sensor processing module without impacting the structure of the terminal or the size of the battery in the terminal. In addition, since the fingerprint identification assembly is attached to one side surface of the display screen 100, it can not only be placed under the display screen 100, but could also be placed above the display screen 100.

It should be noted that in the above description, the term “display module” refers to a screen portion of a terminal including a display screen 100. The display module may include at least a display screen 100, a touch screen 500, and a protective cover plate 600, and the fingerprint collection layer 200 may be attached to one side surface of any one of the display screen 100, the touch screen 500, and the protective cover plate 600.

One of skill would understand that, in the above description, the order of steps S1, S2, and S3 is not limited.

The above step S1 can be implemented in at least the following ways.

In a first way, a substrate layer 210 is formed on one side surface of the display screen 100, the touch screen 500, or the protective cover plate 600, and a detection element and a signal line 220 are formed on the substrate layer 210, to create the fingerprint collection layer 200.

The fingerprint collection layer 200 is directly formed on one side surface of the display screen 100, the touch screen 500, or the protective cover plate 600. The fingerprint collection layer 200 may be manufactured by a process used for a fingerprint collection structure (sensor pattern) on a fingerprint chip die, for example etching, as would be understood by one of skill in the art. The fingerprint collection layer 200 may be manufactured by exposure, development, etching, or other processes known to those of skill.

In a second way, the substrate layer 210 is formed, and the detection element and the signal line 220 are formed on the substrate layer 210 to create the fingerprint collection layer 200. The fingerprint collection layer 200 is attached to one side surface of the display screen 100, the touch screen 500, or the protective cover plate 600.

After the fingerprint collection layer 200 is separately manufactured, it is then attached to a side surface of the display screen 100, the touch screen 500, or the protective cover plate 600 using an attaching method (e.g., Glass+Film+Film (GFF), as would be known to one of skill in the art). The fingerprint collection layer 200 may be manufactured by a process used for a fingerprint collection structure (sensor pattern) on a fingerprint chip die, for example etching, as would be understood by one of skill in the art. The fingerprint collection layer 200 may be manufactured by exposure, development, etching, or other processes known to those of skill.

The above embodiments are for illustrative purposes only, and the present disclosure is not limited thereto. A person skilled in the art may make further modifications and improvements without departing from the spirit of the present disclosure, and these modifications and improvements would also fall within the scope of the present disclosure.

What is claimed is:

1. A terminal comprising a display module and a fingerprint identification assembly, wherein
the fingerprint identification assembly comprises:
a fingerprint collection layer, attached to the display module and configured to collect fingerprint information;
a fingerprint identification module, configured to identify the fingerprint information; and
a flexible circuit board, wherein the flexible circuit board is led out from a side edge of the fingerprint collection layer, and is connected to the fingerprint identification module.

2. The terminal according to claim 1, wherein the fingerprint collection layer comprises: a substrate layer, a detection element disposed on the substrate layer, and a signal line disposed on the substrate layer, and the signal line comprises a reception signal line and a transmission signal line, the reception signal line and the transmission signal line being arranged substantially perpendicular with respect to each other.

3. The terminal according to claim 2, wherein the substrate layer is made of one of silicon, glass, acrylic, or optical film.

4. The terminal according to claim 1, wherein the fingerprint identification assembly is one of an optical fingerprint identification assembly, a semiconductor fingerprint identification assembly, or an ultrasonic fingerprint identification assembly.

5. The terminal according to claim 1, wherein the display module includes a driver IC, and the fingerprint identification module is integrated with the driver IC.

6. The terminal according to claim 1, wherein the display module comprises:
a display screen, including a display surface and a back surface opposite to the display surface;
a touch screen, arranged on a side of the display surface of the display screen; and
a protective cover plate, arranged on a side of the touch screen away from the display screen,
wherein the fingerprint collection layer is attached to the back surface of the display screen.

7. The terminal according to claim 1, wherein the display module comprises:
a display screen, including a display surface and a back surface opposite to the display surface;
a touch screen, arranged on a side of the display surface of the display screen; and
a protective cover plate, arranged on a side of the touch screen away from the display screen,
wherein the fingerprint collection layer is attached between the display screen and the touch screen.

8. The terminal according to claim 1, wherein the display module comprises:
a display screen, including a display surface and a back surface opposite to the display surface;
a touch screen, arranged on a side of the display surface of the display screen; and
a protective cover plate, arranged on a side of the touch screen away from the display screen,
wherein the fingerprint collection layer is attached between the touch screen and the protective cover plate.

9. A method of manufacturing a terminal, the method comprising:
forming a fingerprint collection layer on a display module,
binding the fingerprint collection layer to a flexible circuit board, wherein the binding comprises leading the flexible circuit board out from a side edge of the fingerprint collection layer,
and binding the flexible circuit board to a fingerprint identification module.

10. The method according to claim 9, wherein the fingerprint collection layer comprises: a substrate layer, a detection element disposed on the substrate layer, and a signal line disposed on the substrate layer, the signal line including a reception signal line and a transmission signal line that are arranged substantially perpendicularly with respect to each other, and the display module includes a display screen, a touch screen, and a protective cover plate,
wherein the forming the fingerprint collection layer on the display module comprises:
forming the substrate layer on one of a side surface of the display screen, the touch screen, or the protective cover plate, and
forming the detection element and the signal line on the substrate layer to create the fingerprint collection layer.

11. The method according to claim 10, wherein the forming the substrate layer on one of a side surface of the display screen, the touch screen, or the protective cover plate comprises:
forming the substrate layer;
forming the detection element and the signal line on the substrate layer to create the fingerprint collection layer; and
attaching the fingerprint collection layer on one of a side surface of the display screen, the touch screen, or the protective cover plate.
